(19) United States
(12) Patent Application Publication
(10) Pub. No.: US 2016/0079597 A1
(43) Pub. Date: Mar. 17, 2016

(54) ALL-SOLID LITHIUM ION SECONDARY BATTERY

(71) Applicant: Samsung Electronics Co., Ltd., Suwon-si (KR)

(72) Inventors: Satoshi FUJIKI, Yokohama-city (JP); Yuichi AIHARA, Yokohama-city (JP)

(21) Appl. No.: 14/855,495

(22) Filed: Sep. 16, 2015

(30) Foreign Application Priority Data
Sep. 16, 2014 (JP) 2014-0187673
Jun. 15, 2015 (KR) 10-2015-0084347

(51) Int. Cl. H01M 4/52; H01M 4/36; H01M 10/0562; H01M 4/525; H01M 10/0525

(52) U.S. Cl. CPC H01M 4/523; H01M 4/525; H01M 10/0525; H01M 10/0562; H01M 4/366; H01M 2004/028

(57) ABSTRACT

An all-solid lithium ion secondary battery including a positive electrode including a positive active material particle and a solid electrolyte particle in contact with the positive active material particle, wherein the positive active material particle includes: a lithium cobalt oxide (LCO) particle; a first coating layer which includes nickel and is on at least a portion of a surface of the lithium cobalt oxide particle; and element M¹, selected from B, Mg, Al, Si, Sc, Ti, V, Cr, Mn, Fe, Cu, Zn, Ga, Y, Zr, Nb, Mo, Ru, In, Sn, Sb, La, Ce, Pr, Eu, Tb, Hf, Ta, and Pb.

### CROSS-REFERENCE TO RELATED APPLICATIONS

This application claims priority to and the benefit of Japanese Patent Application No. 2014-0187673, filed on Sep. 16, 2014, in the Japanese Patent Office, and Korean Patent Application No. 10-2015-0084347, filed on Jun. 15, 2015, in the Korean Intellectual Property Office, and all the benefits accruing therefrom under 35 U.S.C. §119, the contents of which are incorporated herein in their entirety by reference.

### BACKGROUND

1. Field

The present disclosure relates to an all-solid lithium ion secondary battery.

2. Description of the Related Art

Since lithium ion secondary batteries have a large charge/discharge capacity, high operating potential, and excellent charge/discharge cycle characteristics, demands for lithium ion secondary batteries for such uses as motorcycles, electric vehicles, and hybrid electric vehicles using personal digital assistants, portable electronic devices, household small power storage devices, and motors as power sources are increasing. Although non-aqueous electrolytic solutions in which lithium salts are dissolved into organic solvents as electrolytes are used in lithium ion secondary batteries, such non-aqueous electrolytic solutions are concerned with safety problems such as easiness of ignition and leakage of the electrolytic solutions. Therefore, active studies have recently been made on all-solid lithium ion secondary batteries using solid electrolytes formed of inorganic materials, i.e., incombustible materials for the purpose of improving safety of lithium ion secondary batteries.

Although sulfides and oxides may be used as solid electrolytes for lithium ion secondary batteries, sulfide based solid electrolytes are attractive because they provide better lithium ion conductivity. However, if the sulfide based solid electrolyte is used, reactions occur in interfaces between positive active material particles and solid electrolyte particles during charging, and resistant components are generated at interfaces resulting in increased resistance (hereinafter, referred to as “interfacial resistance”) when lithium ions are moved across the interfaces between the positive active material particles and the solid electrolyte particles. Since lithium ion conductivity is reduced by the increased interfacial resistance, there are problems that output power of the all-solid lithium ion secondary battery is reduced.

Ni-containing positive active material particles, e.g., lithium nickel cobalt manganese oxide (hereinafter, referred to as “NCM”) particles and nickel cobalt aluminum oxide (hereinafter, referred to as “NCA”) particles as positive active material particles of the all-solid lithium ion secondary batteries have been used up to now due to the above-described problems. The Ni-containing positive active material particles have been used as the positive active material particles of all-solid lithium ion secondary batteries since it is difficult for the Ni-containing positive active material particles to produce resistant components with sulfide based solid electrolytes.

LiCoO₂ (hereinafter, referred to as “LCO”) particles are positive active material particles used in non-aqueous lithium ion secondary batteries. LCO particles have higher true densities than NCM particles and the NCA particles.

Further, the NCM particles and the NCA particles have low lithium ion diffusion velocities. Accordingly, if the NCM particles and the NCA particles are used as the positive active material particles, it is necessary to decrease the primary particle size of the NCM particles and the NCA particles and coagulate, i.e., secondary particles containing of the primary particles. That is because, if the primary particles are large, it takes time for lithium ions to reach all regions of the primary particles, and cycle characteristics of lithium ion secondary batteries are deteriorated. Therefore, a plurality of pores are formed between the positive active material particles in a positive active material layer containing the NCM particles and the NCA particles as the positive active material particles. That is, filling characteristics of the positive active material particles can be reduced to accommodate the lithium ion diffusion velocity. The primary particles of LCO may be used as they are since a lithium ion diffusion velocity of the LCO particles is greater than that of the NCM particles and the NCA particles. Therefore, filling characteristics of the positive active material particles of LCO are improved relative to NCM or NCA materials.

The positive active material layer may have a high density (volume density) if the LCO particles are used as the positive active material particles due to the above-mentioned reason. Accordingly, there remains a need to use the LCO particles in all-solid lithium ion secondary batteries.

However, there have been problems that, if the LCO particles are used as the positive active material particles of the all-solid lithium ion secondary battery, the interfacial resistance is substantially increased, and discharge capacity and cycle characteristics are substantially deteriorated. Thus, it has been suggested that the surface of the positive active material particles is coated with LiNbO₃, Li₄Ti₅O₁₂, or Al compounds. However, satisfactory values of the discharge capacity and cycle characteristics could not be obtained even by such technologies.

### SUMMARY

Provided is a new and improved lithium ion secondary battery which is capable of using LCO particles as a positive active material, and which is capable of providing improved discharge capacity and cycle characteristics in an all-solid lithium ion secondary battery.

Additional aspects will be set forth in part in the description which follows and, in part, will be apparent from the description.

According to an aspect, an all-solid lithium ion secondary battery includes a positive electrode including a positive active material particle and a solid electrolyte particle in contact with the positive active material particle, wherein the positive active material particle includes a lithium cobalt oxide (LCO) particle, a first coating layer which includes a nickel and is on at least a portion of a surface of the lithium cobalt oxide particle, and at least one element M¹ selected from B, Mg, Al, Si, Sc, Ti, V, Cr, Mn, Fe, Cu, Zn, Ga, Y, Zr, Nb, Mo, Ru, In, Sn, Sb, La, Ce, Pr, Eu, Tb, Hf, Ta, and Pb.

According to an aspect, the element M¹ may be at least one element selected from Mg, Al, and Mn.

According to an aspect, the first coating layer may additionally include at least one element selected from lithium, oxygen, and the element M¹.

A whole composition of the positive active material particle may be represented by the following Formula 1:

LiₓNi_{y}Co_{z}M¹_{1-y-z}O₂ Formula 1

wherein x, y, and z are values satisfying 0.5<x<1.2, 0<y<0.4, z>0.6, and y+z≦1.0.

According to an aspect, the positive active material particle may have an average particle diameter of about 5 micrometers (pm) to about 35 μm.

According to an aspect, a molar ratio of nickel and cobalt (Co) in the positive active material particle may continuously vary toward the center of the positive active material particle from the surface of the positive active material particle.

According to an aspect, the element M¹ may be included in the LCO particles.

According to an aspect, the positive active material particle may additionally include a second coating layer on at least a portion of the first coating layer, and the second coating layer may include at least one element M² selected from B, Mg, Al, Si, Sc, Ti, V, Cr, Mn, Fe, Cu, Zn, Ga, Y, Zr, Nb, Mo, Ru, In, Sn, Sb, La, Ce, Pr, Eu, Tb, Hf, Ta, and Pb.

According to an aspect, the element M² may be at least one element selected from Al, Ti, Ga, Y, Zr, Nb, In, La, and Ce.

According to an aspect, moles of the element M² to the total of all transition metals in the positive active material particle may be about 10 mol % or less, based on the moles of all transition metals in the positive active material particle.

According to an aspect, the positive active material particle may have an approximately spherical shape.

According to an aspect, the solid electrolyte particle may be a sulfide-based solid electrolyte particle.

According to an aspect, the sulfide-based solid electrolyte particle includes at least sulfur and lithium, and may additionally include at least one element selected from phosphorous (P), silicon (Si), boron (B), aluminum (Al), germanium (Ge), zinc (Zn), gallium (Ga), indium (In), and halogen elements.

According to an embodiment, the LCO particles may be used as the positive active material particle, and discharge capacities and cycle characteristics of an all-solid lithium ion secondary battery containing the positive active material particle are improved.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a schematic view showing the structure of an embodiment of a lithium ion secondary battery;

FIG. 2 is a schematic view showing the structure of a positive active material particle according to an exemplary embodiment;

FIG. 3 is a schematic view showing an embodiment of a positive electrode layer;

FIG. 4 is a schematic view showing the structure of an embodiment of a positive active material particle;

FIG. 5 is a high angle annular dark field-scanning transmission electron microscope (HAADF-STEM) image showing the cross-section of a positive active material particle obtained in Example 3;

FIG. 6 is an intensity line profile graph of intensity (arbitrary units, a.u.) versus distance (nanometers) showing a correlation between depth from the surface of specimen of the positive active material particles and surface densities (atom %) of O, Co, and Ni in a positive active material particle obtained in Example 3; and

FIG. 7 is a schematic view of an all-solid lithium ion secondary battery showing how increased interfacial resistance occurs.

### DETAILED DESCRIPTION

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects. As used herein, the term “and/or” includes any and all combinations of one or more of the associated listed items. “Or” means “and/or.” Expressions such as “at least one of” when preceding a list of elements, modify the entire list of elements and do not modify the individual elements of the list.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

A C rate is a measure of the rate of a battery is charge or discharged relative to its maximum capacity. A 1C rate means a current which will charge or discharge the entire battery in one hour. For a battery with a capacity of 100 Amp-hrs, this equates to a discharge current of 100 Amps. A 5C rate for this battery would be 500 Amps, and a C/2 rate would be 50 Amps.

Problems of Solid Electrolytes

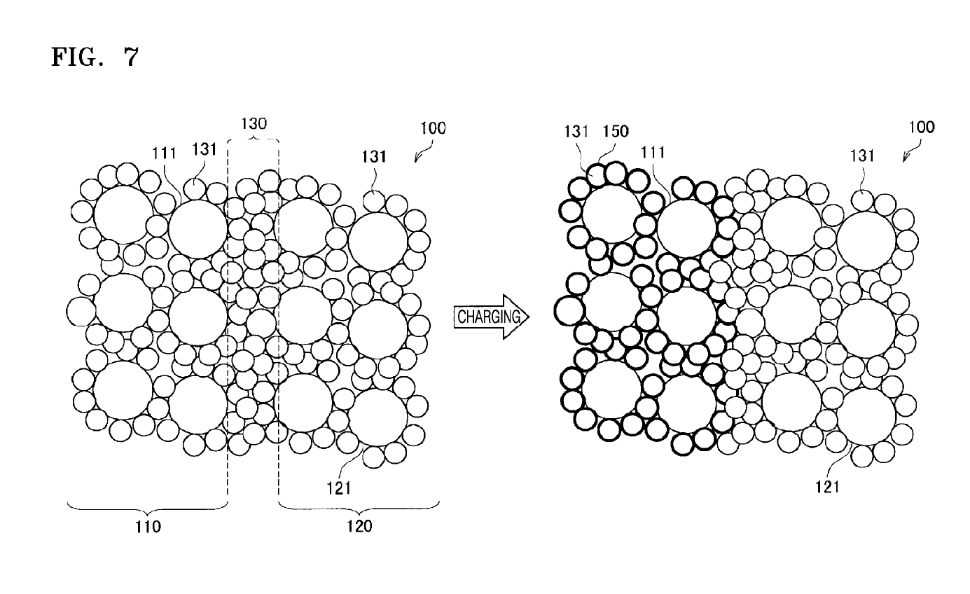

First, problems of using solid electrolytes are described by referring to FIG. 7. FIG. 7 is an explanation drawing showing a schematic structure of a lithium ion secondary battery 100 (hereinafter, referred to as “lithium ion secondary battery 100”).

A lithium ion secondary battery 100 has a structure in which a positive electrode layer 110, a negative electrode layer 120, and a solid electrolyte layer 130 are laminated. The positive electrode layer 110 consists of a particle mixture in which positive active material particles 111 and sulfide-based solid electrolyte particles 131 (hereinafter, referred to as “solid electrolyte particles 131”) are mixed. Similarly, the negative electrode layer 120 is comprised of a particle mixture in which negative active material particles 121 and solid electrolyte particles 131 are mixed. The solid electrolyte layer 130 is disposed between the positive electrode layer 110 and the negative electrode layer 120. The solid electrolyte layer 130 consists of the solid electrolyte particles 131.

In a lithium ion secondary battery 100 using a sulfide-based solid electrolyte, it is difficult for the electrolyte to permeate into the positive active material when using the sulfide-based solid electrolyte compared to when using an organic electrolytic solution as the electrolyte since a positive active material and an electrolyte are solid, and it is difficult to provide a suitable path for lithium ions and electrons since it is easy to reduce an interfacial area of the positive active material and the electrolyte. Therefore, as shown in FIG. 7, a positive electrode layer 110 is formed of a particle mixture in which positive active material particles 111 and sulfide-based solid electrolyte particles 131 are mixed, and a negative electrode layer 120 is formed of a particle mixture in which negative active material particles 121 and sulfide-based solid electrolyte particles 131 are mixed. An interfacial area of an active material and a solid electrolyte is increased in the positive electrode layer 110 and the negative electrode layer 120.

However, as described above, a reaction occurs at an interface between the positive active material particles 111 and the solid electrolyte particles 131 during the charging process such that a high resistance layer 150 is formed. Specifically, the high resistance layer 150 is formed by a reaction (e.g., a side reaction) between transition metals present in the surface of the positive active material particles 111 and oxygen and sulfur in the surface of the solid electrolyte particles 131. Here, the “high resistance layer 150” is a layer consisting of resistance components formed at an interface between the positive active material particles 111 and the solid electrolyte particles 131, and is a layer in which a resistance to lithium ion transport is increased relative to the inner parts of the positive active material particles 111 or the sulfide-based solid electrolyte particles 131. Therefore, it is easy to increase an interfacial resistance between the positive active material particles 111 and the solid electrolyte particles 131. When an interfacial area between the positive active material particles 111 and the solid electrolyte particles 131 is increased, it is easier to form the high resistance layer 150 while a moving path of lithium ions and electrons may be provided. Because of this, movement of lithium ions from the positive active material particles 111 to the solid electrolyte particles 131 are impeded by the high resistance layer 150. As a result, an output power of a lithium ion secondary battery 100 is reduced since conductivity of lithium ions is reduced.

Due to the above problems, a Ni-containing positive active material particle, e.g., a nickel cobalt manganese (NCM) particle or nickel cobalt aluminum (NCA) particle as a positive active material particle of an all-solid lithium ion secondary battery, has been used because, while not wanting to be bound by theory, it is difficult for the Ni-containing positive active material particle to produce resistance components with sulfide-based solid electrolytes.

A lithium cobalt oxide (LCO) particle is a positive active material particle used in a non-aqueous lithium ion secondary battery. When the LCO particle is used as the positive active material particle of the non-aqueous lithium ion secondary battery, a positive active material layer may have an improved volumetric density. Due to the improved volumetric density, there is a desire to use the LCO particle in an all-solid lithium ion secondary battery.

However, when the LCO particle is used as the positive active material particle of the all-solid lithium ion secondary battery 100, there are problems that the interfacial resistance due to the high resistance layer 150 is substantially increased, and discharge capacity and cycle characteristics are substantially reduced. Therefore, methods of coating the surface of the positive active material particles with LiNbO₃, Li₄Ti₅O₁₂, or Al compounds have been considered. However, coating the surface of the positive active material particles with LiNbO₃, Li₄Ti₅O₁₂, or Al compounds has not provided suitable values of the discharge capacity and cycle characteristics.

Ni Coated LCO

It has been surprisingly discovered that coating an LCO particle with nickel provides improved results. While not wanting to be bound by theory, it is understood that the reason is that it is difficult for the nickel atom to form the high resistance layer 150 with a sulfide-based solid electrolyte. In addition, it has been discovered that adding elements M¹ and M² to the coated particle provides further improvement. Examples of a form for introducing the element M¹ may include a form of additionally adding M¹ to the coated particle, e.g. in the state of a solid solution, and other forms. Examples of a form for introducing the element M² may include a form of additionally coating the coated particle with the element M², and other forms. Hereinafter, an embodiment of a lithium ion secondary battery is described in detail.

Structure of the Lithium Ion Secondary Battery

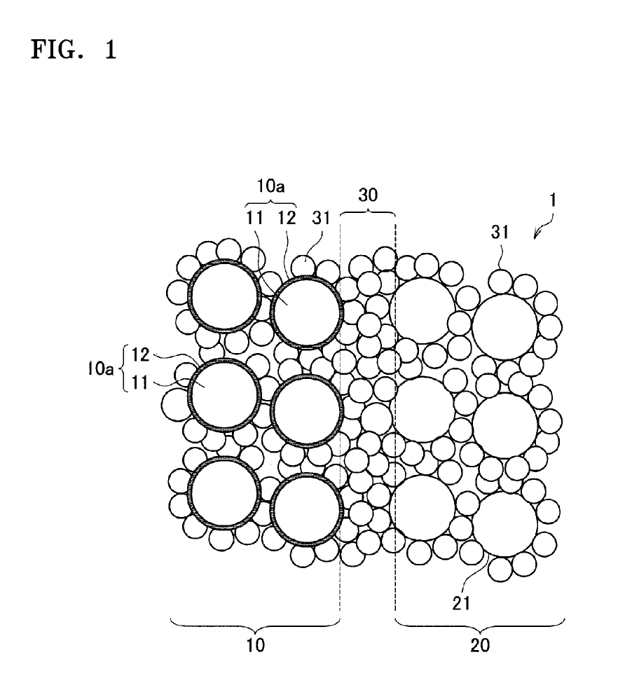

Successively, the structure of a lithium ion secondary battery is described in further detail by referring to FIG. 1. FIG. 1 is a schematic drawing showing the structure of an embodiment of a lithium ion secondary battery 1.

As shown in FIG. 1, a lithium ion secondary battery 1 according to an embodiment is an all-solid lithium ion secondary battery, and has a structure in which a positive electrode layer 10, a negative electrode layer 20, and a solid electrolyte layer 30 are disposed between the positive electrode layer 10 and the negative electrode layer 20.

Positive Electrode Layer 10

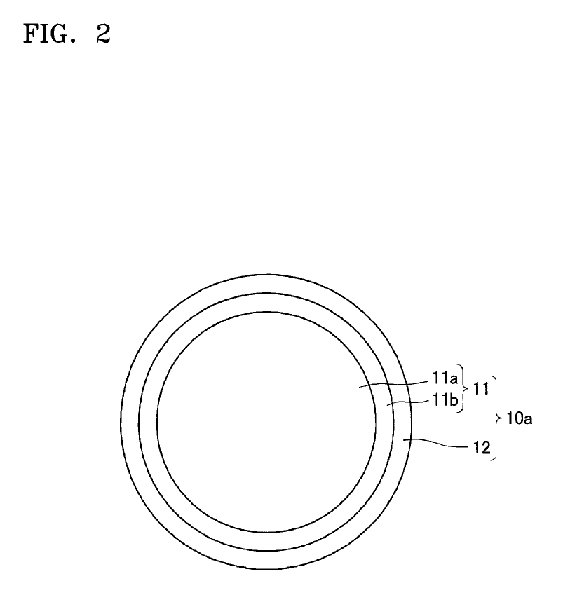

The positive electrode layer 10 includes a particle mixture in which a coated particle 10a and a solid electrolyte particle 31 are mixed. As shown in FIG. 2, the coated particle 10a includes a positive active material particle 11 and a second coating layer 12.

Positive Active Material Particle 11

The positive active material particle 11 includes a LCO particle 11a and a first coating layer 11b. The LCO particle 11a comprises LCO. The LCO particle 11a is formed in an approximately spherical shape. The LCO particle 11a may include a component that is inevitably mixed with the LCO particle 11a during the preparation of the coated particle 10a. For example, when a precursor of the first coating layer 11b is calcined, a nickel atom may be moved from the first coating layer 11b to the LCO particle 11a. Therefore, the LCO particle 11a may include nickel.

Further, the LCO particle 11a may include an element M¹ in the state of a solid solution. The element M¹ may be at least one element selected from of B, Mg, Al, Si, Sc, Ti, V, Cr, Mn, Fe, Cu, Zn, Ga, Y, Zr, Nb, Mo, Ru, In, Sn, Sb, La, Ce, Pr, Eu, Tb, Hf, Ta, and Pb. The element M¹ may be at least one element selected from Mg, Al, and Mn. The element M¹ may be contained in an amount of about 10 mole percent (mol %) or less with respect to the moles of cobalt included in LCO, and the content of the element M¹ is determined to satisfy Formula 1.

The first coating layer 11b covers at least a portion of the surface of the LCO particle 11a. The first coating layer 11b includes at least nickel. The first coating layer 11b may additionally include at least one element selected from lithium, oxygen, and an element M¹. Contents of nickel, lithium, and element M¹, and molar ratios thereof may be determined to satisfy Formula 1.

A whole composition of positive active material particle 11 may be represented by the following Formula 1:

LiₓNi_{y}Co_{z}M¹_{1-y-z}O₂ Formula 1

wherein M¹ is the element M¹, and x, y, and z are values satisfying 0.5<x<1.2, 0<y<0.4, z>0.6, and y+z≦1.0.

Further, the positive active material particle 11 may have an average particle diameter of about 5 μm to about 35 μm, about 10 μm to about 30 μm, or about 15 μm to about 25 μm. Here, the positive active material particle 11 has a particle diameter that is a particle diameter obtained when the positive active material particle 11 is considered to be formed in the form of a spherical body. Further, the average particle diameter may have a particle size value D50 (central value diameter) of the positive active material particle 11. If the positive active material particle 11 has an average particle diameter of less than about 5 μm, discharge capacity and cycle characteristics of a lithium ion secondary battery 1 may be reduced even when the positive active material particle 11 has an average particle diameter of more than about 35 μm.

An average particle diameter of the positive active material particle 11 may be measured by a dry type particle size distribution measuring device, e.g., Microtrac MT-3000II by Nikkiso Co., Ltd. Average particle diameters of the positive active material particles 11 and other particles were measured by using this device in the examples described later.

The positive active material particle 11 may have an approximately spherical shape. In this case, an all-solid lithium ion secondary battery 1 may have more improved discharge capacity and cycle characteristics.

Further, a molar ratio of nickel to cobalt in the positive active material particle 11 may continuously vary from the surface of the positive active material particle 11 toward the center of the positive active material particle. Specifically, the longer a distance is from the surface of the positive active material particle 11 (or the coated particle 10a) to the measuring face, the more a surface density (the number of atoms per unit area) of the nickel atom is decreased. On the other hand, the longer a distance is from the surface of the positive active material particle 11 (or the coated particle 10a) to the measuring face, the more a surface density of the cobalt atom is increased. Such variations may occur in an interface between the LCO particle and the first coating layer 11b and an area in the vicinity thereof.

Second Coating Layer 12

A second coating layer 12 covers at least a portion of the surface of the first coating layer 11b. The second coating layer 12 includes at least element M². The element M² is at least one element selected from B, Mg, Al, Si, Sc, Ti, V, Cr, Mn, Fe, Cu, Zn, Ga, Y, Zr, Nb, Mo, Ru, In, Sn, Sb, La, Ce, Pr, Eu, Tb, Hf, Ta, and Pb. The element M² may be at least one element selected from Al, Ti, Ga, Y, Zr, Nb, In, La, and Ce.

The positive active material particle 11 may have about 10.0 mol % or less of the element M² relative to the total atom number (the total moles) of all transition metals (e.g., the nickel atom and the cobalt atom). Further, the second coating layer 12 may include at least one of lithium and oxygen. A lithium ion secondary battery 1 may have more improved discharge capacity and cycle characteristics by coating the positive active material particle 11 with the second coating layer 12 having the above composition. Furthermore, although a lower bound to the content of the element M² is not particularly limited, the element M² may have, for example a lower content limit of about 0.1 mol %. In this case, discharge capacity and cycle characteristics may be further improved. In an embodiment, a content of M² relative to a total content of all transition metals positive active material particle may be 0.01 mol % to 10 mol %, 0.1 mol % to 5 mol %, or 0.2 mol % to 3 mol %.

Since the coated particle 10a has the above-described structure, a reaction (side effect) between a sulfur element in solid electrolyte particle 31 and a transition metal element in the positive active material particle 11 is suppressed, and discharge capacity and cycle characteristics of a lithium ion secondary battery 1 may be improved.

Further, it can be confirmed that a first coating layer 11b and a second coating layer 12 are formed on the surface of LCO particle 11a by methods such as a method for analyzing microscopic images (Field Emission-Scanning Electron Microscope (FE-SEM) images and Transmission Electron Microscope (TEM) images) using a contrast difference caused by a structural difference between the coating layers of the positive active material particle 11. The structure of the positive active material particle 11 was checked by HAADF-STEM as is disclosed in the Examples described later.

Other Additives

Additives such as a conducting agent, a binder, an electrolyte, a filler, a dispersant, and an ion conducting agent, as well as the positive active material particles 11 may be appropriately selected and contained in a positive electrode layer 10.

Examples of the conducting agent may include graphite, carbon black, acetylene black, Ketjen black, carbon fibers, and metal powders. Examples of the binder may include polytetrafluoroethylene, polyvinylidene fluoride, and polyethylene. Examples of the electrolyte may include a sulfide-based solid electrolyte. Suitable materials used in electrodes of lithium ion secondary batteries may be used as the filler, dispersant, or ion conducting agent.

Modified Embodiment of Positive Electrode Layer 10

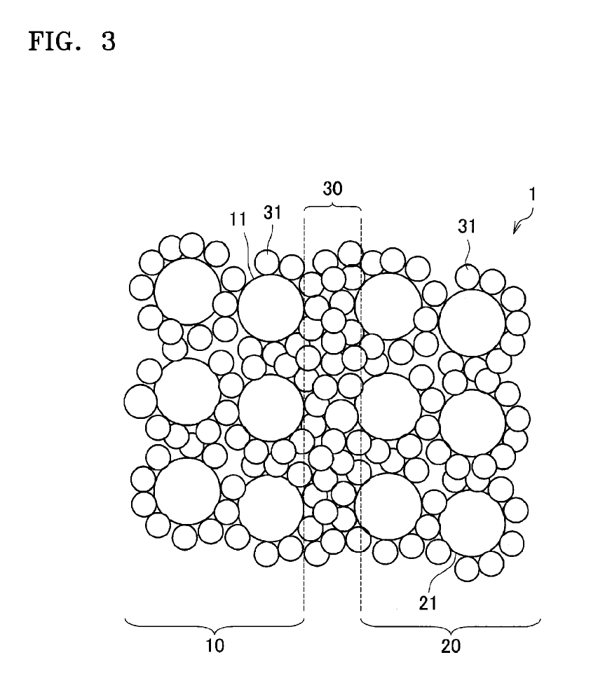

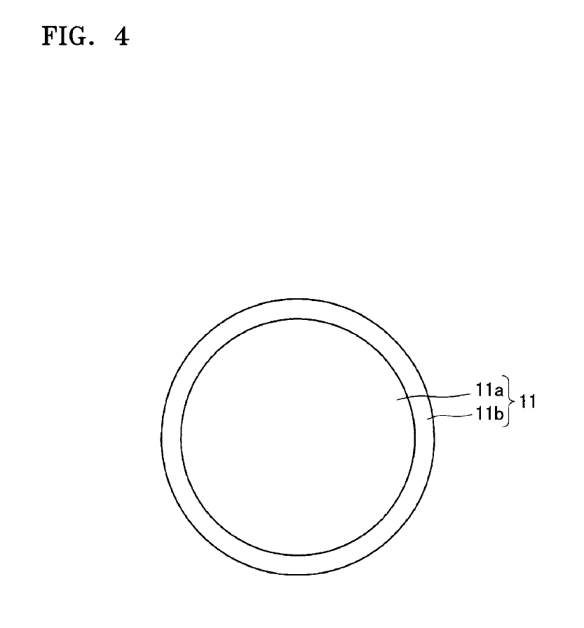

FIG. 3 shows a modified embodiment of a positive electrode layer 10. As shown in FIG. 3, a positive electrode layer 10 according to a modified embodiment includes a positive active material particle 11 and a solid electrolyte particle 31. As shown in FIG. 4, the positive active material particle 11 is obtained by excluding a second coating layer 12 from the above-described coated particle 10a. As represented in embodiments described layer, this modified embodiment may have improved discharge capacity and cycle characteristics.

Negative Electrode Layer 20

Negative Active Material Particle 21

A negative active material particle 21 included in a negative electrode layer is not particularly limited, and may be a negative active material particle that includes a material that is alloyable with lithium or is capable of performing reversible intercalation/deintercalation of lithium.

Examples of the negative active material particle 21 may include at least one material selected from lithium, a metal that is alloyable with lithium, a transition metal oxide, a non-transition metal oxide, a material that is capable of doping and dedoping lithium, and a carbonaceous material.

Examples of the metal that is alloyable with lithium may include Si, Sn, Al, In, Ge, Pb, Bi, Sb, Si—Y′ alloys (wherein Y′ is an alkali metal, alkaline earth metal, a Group 13 element, a Group 14 element, a transition metal, a rare earth element, or a combination thereof with Y′ not being Si), Sn—Y″ alloys (wherein Y″ is an alkali metal, an alkaline earth metal, a Group 13 element, a Group 14 element, a transition metal, a rare earth element, or a combination thereof with Y″ not being Sn). Examples of the element Y′ and Y″ may each independently include Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, and combinations thereof.

Examples of the transition metal oxide may include tungsten oxides, molybdenum oxides, titanium oxides, lithium titanium oxides, vanadium oxides, lithium vanadium oxides.

Examples of the non-transition metal oxide may include SnO2, SiOₓ (0<x<2).

Examples of the material that is capable of doping and dedoping lithium may include Si, SiO₂, Si—Y alloys, Sn, SnO₂, Sn—Y′″ alloys (Y′″ is an alkali metals, an alkaline earth metal, a Group 11 element, a Group 12 element, a Group 13 element, a Group 14 element, a Group 15 element, a Group 16 element, a transition metal, a rare earth element, or a combination thereof with Y′″ not being Sn). Examples of the element Y′″ may include Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, and combinations thereof.

The carbonaceous material may be crystalline carbon, amorphous carbon, or mixtures thereof. Examples of the carbonaceous material may include natural graphite, artificial graphite, graphite carbon fiber, resin calcined carbon, pyrolysis vapor phase grown carbon, cokes, mesocarbon micro beads (MCMB), furfuryl alcohol resin calcined carbon, polyacene, pitch based carbon fiber, vapor phase grown carbon fiber, soft carbon or hard carbon, mesophase pitch carbides. The examples of the carbonaceous material may be used in an independent form or in a mixed form of two or more thereof.

The carbonaceous material may have an atypic shape, a plate-like shape, a flake shape, a spherical shape, a fibrous shape, or combinations thereof.

Such a negative active material particle 21 may be used in an independent form or in a mixed form of two or more thereof.

Other Additives

Further, additives such as a conducting agent, a binder, an electrolyte, a filler, a dispersant, an ion conducting agent as well as the negative active material particle 21 may be appropriately selected and contained in a negative electrode layer 20. Such specific examples may include materials such as the above-described positive electrode layer 10.

Solid Electrolyte Layer 30

A solid electrolyte layer 30 according to an embodiment includes a solid electrolyte particle 31. The solid electrolyte particle 31 may be a sulfide-based solid electrolyte particle.

Examples of the solid electrolyte particle 31, as the sulfide-based solid electrolyte particles, may include at least sulfur and lithium, and may additionally include at least one element selected from phosphorous (P), silicon (Si), boron (B), aluminum (Al), germanium (Ge), zinc (Zn), gallium (Ga), indium (In), and halogen elements. The solid electrolyte particle 31 satisfying such conditions, i.e., a sulfide-based solid electrolyte is known to have a higher lithium ion conductivity than other inorganic compounds. Specific examples of the solid electrolyte particle 31 may include Li₂S and P₂S₅. Other examples of the solid electrolyte particle 31 may include SiS₂, GeS₂, and B₂S₃. Further, examples of the sulfide-based solid electrolyte may include inorganic solid electrolytes obtained by adding Li₃PO₄, halogen, halogen compounds, LISICON, LIPON (e.g., Li_{3+y}PO₄₋ₓNₓ), Thio-LISICON (e.g., Li_{3.25}Ge_{0.25}P_{0.75}S₄), or Li₂O—Al₂O₃—TiO₂—P₂O₅ (LATP) to the solid electrolyte completed from Li₂S—P₂S₅, SiS₂, GeS₂, B₂S₃, or combinations thereof. Further, the solid electrolyte particle 31 may have Li₃PO₄, halogen, halogen compounds, etc added thereto.

Specific examples of sulfide-based solid electrolyte material may include Li₂S—P₂S₅, Li₂S—P₂S₅—LiX (wherein X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are positive numbers, and Z is Ge, Zn, or Ga), Li₂S—GeS₂, Li₂S—SiS₂—Li₃PO₄, Li₂S—SiS₂—LiₚMO_{q} (wherein p and q are positive numbers, and M is P, Si, Ge, B, Al, Ga, or In).

According to an embodiment, examples of the solid electrolyte layer 30 may include the sulfide-based solid electrolyte material in which sulfur (S), phosphorous (P), and lithium (Li) as at least composition elements are included, e.g., Li₂S—P₂S₅.

For example, the sulfide-based solid electrolyte material that forms the solid electrolyte layer 30 includes Li₂S—P₂S₅, a mixing molar ratio of Li₂S and P₂S₅ may be selected from a range of about 50:50 to about 90:10.

For example, the solid electrolyte particle 31 may be formed in a true spherical particle shape, or an elliptical spherical particle shape. Particle diameters of the solid electrolyte particle 31 are not particularly limited. For example, the solid electrolyte particle 31 may have an average particle diameter of about 0.01 μm to about 30 μm. For specific example, the solid electrolyte particle 31 may have an average particle diameter of about 0.01 μm to about 20 μm. The average particle diameter represents a number average diameter of the particle size distribution of particles obtained by a scattering method, as described above.

Method for Manufacturing Lithium Ion Secondary Battery

The structure of a lithium ion secondary battery 1 according to an embodiment has been described above in detail. A method for manufacturing a lithium ion secondary battery 1 having the above-described structure is further described below. The lithium ion secondary battery 1 may be manufactured by preparing a positive electrode layer 10, a negative electrode layer 20, and a solid electrolyte layer 30, and then laminating the respective layers. Hereinafter, respective processes are further described.

Preparation of Positive Active Material Particles 11

First, a method for preparing positive active material particle 11 is described. For example, the method for preparing positive active material particle 11 is not particularly limited, and the positive active material particle 11 may be prepared by the following manufacturing method.

After lithium carbonate (Li₂CO₃) and cobalt oxide (Co₃O₄) are mixed at a molar ratio of Li:Co=1.00:1.00, the mixture is calcined while blowing air into the mixture. Here, for example, the calcination temperature is about 950° C., and the calcination time is about 4 hours. The LCO particle 10a is prepared accordingly. Further, when the element M¹ is employed in the LCO particle, a compound including the element M¹ is additionally mixed with the mixture of lithium carbonate (Li₂CO₃) and cobalt oxide (Co₃O₄) to calcine the resulting mixture. The compound including the element M¹ is varied depending on the element M¹. For example, magnesium hydroxide (Mg(OH)₂) may be used if the element M¹ is magnesium.

Subsequently, a powder mixture is prepared by mixing lithium hydroxide (LiOH), nickel hydroxide (Ni(OH)₂), and the compound including the element M¹ at a desired molar ratio. Here, the compound including the element M¹ is varied depending on the element M¹. For example, aluminum hydroxide (Al(OH)₃) may be used if the element M¹ is aluminum. Further, lithium hydroxide (LiOH), nickel hydroxide (Ni(OH)₂), and the compound including the element M¹ may be mixed at a molar ratio of about 1.00:0.95:0.05 such that nickel atom in the positive active material particle 11 and the element M¹ have a desired molar ratio of about 95:5.

Subsequently, the powder mixture and the LCO particle 11a are mixed such that cobalt atom and nickel atom in the positive active material particle 11, and the element M¹ have a desired molar ratio with respect to the total atom number. In succession, a composite of the powder mixture is formed using a mill, such as a NOB-MINI manufactured by Hosokawa Micron Corporation. Accordingly, a precursor of the first coating layer 11b is supported on the surface of the LCO particle 11a. Subsequently, the precursor coated LCO particle is calcined while blowing oxygen into the precursor coated LCO particle. For example, the calcination temperature is about 750° C., and the calcination time is about 4 hours. The positive active material particle 11 is obtained by calcining the precursor coated LCO particle.

The positive active material particle 11 obtained in the process has a particle size distribution. Thus, a classifying process may be performed on the positive active material particle 11 such that the positive active material particle 11 may have a desired average particle diameter value. For example, the positive active material particle 11 may be classified to provide a selected average particle diameter using a centrifugal classifier (e.g., Picoline manufactured by Hosokawa Micron Corporation). An average particle diameter of the positive active material particle 11 may be measured by a dry type particle size distribution-measuring device (e.g., Microtrac MT-300011 by Nikkiso Co., Ltd.). Average particle diameter may be selected by such a method in exemplary embodiments described later.

Preparation of Second Coating Layer 12

Next, a method for preparing the second coating layer 12 is described. First, lithium alkoxide and an alkoxide of the element M² are stirred and mixed in a solvent consisting of water and an organic solvent such as alcohol or ethyl acetoacetate to prepare an alcohol solution (coating solution) of lithium and element M². Here, a concentration of the alkoxide of the element M² is determined such that a molar ratio of the element M² to the total element number of the whole transition metal (e.g., nickel atom and cobalt atom) in the positive active material particle 11 becomes about 10.0 mol % or less. A lower molar ratio limit of the element M² is not particularly limited, the lower molar ratio limit of the element M² may be about 0.1 mol %.

Lithium alkoxide and alkoxide of the element M2 may be obtained by reacting lithium and organic matters including the element M² (e.g., an organo-lithium compound such as butyl lithium) with alcohol. Further, an agitation mixing time is not particularly limited, and for example, the agitation mixing time may be about 30 minutes. Further, in a compound having a CH₃—CO—CH₂—CO—O—R structure such as ethyl acetoacetate, two carbonyl groups in the structure function as a chelating agent such that the compound has an effect of stabilizing unstable metals. Therefore, the compound may function as a stabilizer of the alkoxide of the element M².

Next, a coating solution is mixed with the above-described positive active material particle 11. Subsequently, while stirring a mixed solution of the coating solution and the positive active material particle 11, the mixed solution is heated to about 40° C. to evaporate all of the solvent, such as alcohol. The evaporation of the solvent is performed while irradiating ultrasonic waves to the mixed solution. This enables a precursor of the second coating layer 12 to be supported on the surface of the positive active material particle 11.

Further, the precursor of the second coating layer 12 supported on the surface of the positive active material particle 11 is calcined. At this time, the precursor of the second coating layer 12 may have a calcination temperature of about less than 400° C. The second coating layer 12 may become amorphous at the calcination temperature of about less than 400° C. Further, a calcination time of the precursor of the second coating layer 12 is not particularly limited. For example, the precursor of the second coating layer 12 may have a calcination time of about 1 hour to about 2 hours. Further, calcination is performed on the precursor of the second coating layer 12 while blowing oxygen gas into the precursor of the second coating layer 12. Capacity may be maintained by blowing the oxygen gas into the precursor of the second coating layer 12, thereby suppressing the reduction of nickel in a positive electrode material including nickel. The second coating layer 12 may be coated on the surface of the positive active material particle 11 by the process. That is, coating particles 10a may be prepared. Further, when preparing a positive electrode layer 10 according to modified exemplary embodiments, the preparation process of the second coating layer 12 may be omitted.

Preparation of Solid Electrolyte Particle 31

Examples of a method for preparing the solid electrolyte particle 31 are not particularly limited, but ordinary preparation methods may be applicable to the examples of the method for preparing the solid electrolyte particle 31. For example, the solid electrolyte particle 31 may be prepared by a melting and rapid cooling method or a mechanical milling (MM) process. Hereinafter, a method for preparing solid electrolyte particles 31 including Li₂S and P₂S₅ is described as an example of the method for preparing solid electrolyte particles 31.

For example, the method for preparing solid electrolyte particles 31 by the melting and rapid cooling method may include mixing predetermined amounts of Li₂S and P₂S₅ to form a pellet type mixture, reacting the pellet type mixture at a predetermined reaction temperature under vacuum to produce a reaction product, and rapidly cooling the reaction product to obtain a sulfide-based solid electrolyte. For example, the reaction temperature may be about 400° C. to about 1000° C., and more specifically about 800° C. to about 900° C. Further, for example, the reaction time may be about 0.1 hour to about 12 hours, more specifically about 1 hour to about 12 hours. Further, the reaction product may have a rapid cooling temperature of generally about 10° C. or less, specifically about 0° C. or less, and the reaction product may have a cooling rate of generally about 1 K°/sec to about 10000 K°/sec, specifically about 1 K°/sec to about 1000 K°/sec.

For example, the method for preparing solid electrolyte particles 31 by the MM process may include mixing predetermined amounts of Li₂S and P₂S₅ to form a mixture, and reacting the mixture by the MM process for a predetermined reaction time to obtain a sulfide-based solid electrolyte. The MM process using such starting materials has a merit that the reaction may be performed at room temperature. Since the solid electrolyte may be prepared at room temperature by the MM process, pyrolysis of the raw materials does not occur, and a solid electrolyte of injected components may be obtained. A rotation speed or the rotation time of the MM process is not particularly limited. However, the faster the rotation speed is the faster a production rate of the solid electrolyte may be, and the longer the rotation time, the higher the conversion ratio of the starting materials into the solid electrolyte may be.

Thereafter, the obtained solid electrolyte is heat-treated at a predetermined temperature, and the heat-treated solid electrolyte is milled to obtain the solid electrolyte particle 31. A sulfide including Li₂S and P₂5₅ may have a mixing molar ratio of ordinarily about 50:50 to 80:20, specifically about 60:40 to about 75:25.

Preparation of positive electrode layer 10

A mixture of the coated particle 10a (or the positive active material particle 11), the solid electrolyte particle 31, and various additives is added to a solvent to prepare a positive electrode material mixture of a slurry phase or a paste phase. The solvent is not particularly limited and any solvent suitable for the preparation of a positive electrode material mixture may be used. For example, a nonpolar solvent may be used as the solvent since it is difficult to react the nonpolar solvent with the solid electrolyte particles 31. Subsequently, the obtained positive electrode material mixture may be coated on a current collector using a doctor blade, and the positive electrode material mixture coated on the current collector may be dried. In succession, the current collector and a positive electrode material mixture layer are compacted by a rolling roll and others to obtain a positive electrode layer 10.

Examples of a usable current collector may include a plate-shaped body, or a thin-shaped body formed of stainless steel, titanium, aluminum, or alloys thereof. Further, without using the current collector, the positive electrode material mixture is compaction molded into a pellet shape to obtain a positive electrode layer 10.

Preparation of Negative Electrode Layer 20

A method for preparing a negative electrode layer 20 is as follows. For example, a mixture of the negative active material particle 21, solid electrolyte particles 31, and various additives is added to a solvent to prepare a negative electrode material mixture of a slurry phase or a paste phase. The solvent is not particularly limited and any solvent suitable for the preparation of a negative electrode material mixture may be used. For example, a nonpolar solvent may be used as the solvent since it is difficult to react the nonpolar solvent with the solid electrolyte particle 31. Subsequently, the obtained negative electrode material mixture may be coated on a current collector using a doctor blade and the negative electrode material mixture coated on the current collector is dried. In succession, the current collector and a negative electrode material mixture layer are compacted by a rolling roll and others to obtain a negative electrode layer 20.

Examples of a usable current collector may include a plate-shaped body or a thin-shaped body formed of copper, stainless steel, nickel, or alloys thereof. Further, without using the current collector, a mixture of the negative active material particles 21 and various additives can be compaction molded into a pellet shape to obtain a negative electrode layer 20. Further, if metals or alloys of the metals are used as the negative active material particles 21, metal sheets (foils) as the negative active material particles 21 may be used as they are.

Preparation of Solid Electrolyte Layer 30

A method for preparing the solid electrolyte layer 30 is as follows. The solid electrolyte layer 30 may be prepared by forming a film from the solid electrolyte particle 31 using a suitable film forming methods such as a spray process, a sputtering process, a vapor phase growth process (CVD), or a thermal spray process. Further, when the solid electrolyte layer 30 is prepared, it is also better to use a method for forming a film after coating a mixed solution of a solvent and a binder (e.g., a polymer compound) on the solid electrolyte particle 31 and removing the solvent from the mixed solution coated on the solid electrolyte particle 31. Further, a film may be formed by pressing an electrolyte in which the solid electrolyte particle 31 itself, or the solid electrolyte particle 31 and the binder, or supports (materials or compounds for reinforcing strength of the solid electrolyte particle 31 and preventing short-circuit of the solid electrolyte particles 31 themselves) are mixed.

4.7. Lamination of Respective Layers

A lithium ion secondary battery 1 may be manufactured by successively laminating and pressing the obtained positive electrode layer 10, solid electrolyte layer 30, and negative electrode layer 20 after obtaining the positive electrode layer 10, solid electrolyte layer 30, and negative electrode layer 20 by performing the processes as mentioned above.

### EXAMPLES

Hereinafter, exemplary embodiments are described more in detail through the following Examples and Comparative Examples. However, such embodiments are provided for illustrative purposes only, and the scope of the present invention should not be limited thereto in any manner. Further, it should be understood that the present disclosure is not limited to the above descriptions since other various modifications may occur to persons having ordinary knowledge in the related art.

### Example 1

1.1 Preparation of Positive Active Material Particle 11

After mixing lithium carbonate and cobalt oxide at a molar ratio of about Li:Co=1.00:1.00, the mixture was calcined at about 950° C. for about 4 hours while blowing air into the mixture. A lithium cobalt oxide (LCO) particle 11a was obtained by calcining the mixture. As a result of measuring an average particle diameter of the LCO particle 11a by the above-described method, the average particle diameter of the LCO particle 11a was about 18 μm.

Subsequently, a powder mixture was prepared by mixing lithium hydroxide, nickel hydroxide, and aluminum hydroxide at a molar ratio of about Li:Ni:Al=1.00:0.95:0.05. The powder mixture and the LCO particle 11a were mixed such that a molar ratio of cobalt atom to a sum of nickel atom and aluminum atom became about Co:(Ni+Al)=0.95:0.05.

In succession, the powder mixture was composited using a NOB-MINI manufactured by Hosokawa Micron Corporation. Accordingly, a precursor (lithium-nickel-aluminum oxide precursor) of the first coating layer 11b was supported on the surface of the LCO particle. Subsequently, the precursor was calcined at about 750° C. for about 4 hours while blowing oxygen into the precursor. The positive active material particle 11 was obtained by the calcination process. A composition for the positive active material particle 11 was LiCo_{0.95}(Ni_{0.95}Al_{0.05})_{0.05}O₂. As a result of measuring an average particle diameter of the positive active material particle 11 by the above-described method, the average particle diameter of the positive active material particle 11 was about 19 μm.

1.2 Preparation of Solid Electrolyte Particles 31

Solid electrolyte particle 31 was obtained by mixing Li₂S and P₂5₅ at a molar ratio of about 60/20 through a mechanical milling process. The solid electrolyte particle 31 had an average particle diameter D50 of about 10 μm. Here, the average particle diameter is an average particle diameter of a secondary particle of the solid electrolyte particle 31. Further, the secondary particle was considered to be spherical when measuring the average particle diameter.

1.3 Manufacturing of a Lithium Ion Secondary Battery

A lithium ion secondary battery 1 was manufactured by the following processes. Further, the following processes were all performed in an inert gas atmosphere. The positive active material particle 11, the solid electrolyte particle 31, and carbon black powder as a conducting agent were mixed at a mass ratio of about 60:35:5 using a mortar until the mixture became uniform. Thereby, a positive electrode material mixture was obtained. About 30 milligrams (mg) of the positive electrode material mixture was inserted into a molding jig, and the positive electrode material mixture was press molded at a pressure of about 2 ton/cm² to pelletize the positive electrode material mixture. The pelletized positive electrode material mixture was laminated on a stainless steel current collector to prepare a positive electrode layer 10.

Subsequently, about 100 mg of the solid electrolyte particle 31 was inserted into a molding jig, and the solid electrolyte particle 31 was press-molded at a pressure of about 2 ton/cm² to prepare a solid electrolyte layer 30. The positive electrode layer was inserted into the molding jig, and the positive electrode layer was press molded at a pressure of about 2 ton/cm² to integrate the solid electrolyte layer 30 and the positive electrode layer 10.

In succession, the graphite powder (which is a negative electrode material mixture vacuum-dried at about 80° C. for about 24 hours) was press molded at a pressure of about 4 ton/cm² after inserting about 30.0 mg of the graphite powder into a molding jig, such that the solid electrolyte layer 30 was combined with the positive electrode layer 10 and the negative electrode layer 20. Thereby, the solid electrolyte layer 30 and the negative electrode layer 20 were integrated. A cell for testing was obtained by the above-described processes.

1.4 Cycle Lifetime Test

A charge/discharge cycle test was performed to a constant current of about 0.05C at room temperature (about 25° C.) using the obtained cell for testing. Specifically, a charge/discharge cycle including charging the cell for testing at a constant current of about 0.05C at about 25° C. to an upper limit voltage of about 4.2 V, and discharging the charged cell for testing to a final discharge voltage of about 2.5 V was repeatedly performed about 50 times. A discharge capacity retention ratio was defined by a ratio of discharge capacity of the 50^{th} cycle to discharge capacity (initial capacity) of the first cycle. The discharge capacity retention ratio is a parameter showing cycle characteristics, and the higher value of the discharge capacity retention rate is, the more excellent cycle characteristics of the cell for testing are.

### Example 2

A powder mixture of lithium hydroxide, nickel hydroxide, and aluminum hydroxide was mixed with the LCO particle 11a such that a molar ratio of cobalt to the sum of nickel and aluminum became about Co:(Ni+Al)=0.90:0.10. Except this, the same preparation processes were performed as in Example 1. Positive active material particle 11 had an average particle diameter of about 20 μm.

### Example 3

The following preparation processes were performed to prepare the coated particle 11a, and to prepare a cell for testing using the coated particle 11a. Except this, the same preparation processes were performed as in Example 1.

3.1 Preparation of Coating Particles 10a

A 10% lithium methoxide methanol solution and Zr (IV) propoxide were mixed in an isopropyl alcohol solution for about 30 minutes such that Zr (IV) propoxide was dissolved into the lithium methoxide methanol solution. Thereby, a mixed solution was prepared. Subsequently, the positive active material particle 11 prepared in Example 1 were injected into the mixed solution.

Here, when zirconium atom included in Zr (IV) propoxide had a mol number of about n¹, and the whole transition metal (nickel atom and cobalt atom in Example 3) in the positive active material particle 11 had a total atom number of about n², a concentration of the mixed solution and an injection amount of the positive active material particle 11 were adjusted such that a ratio of n¹ to n2 (i.e., a value of n¹/n²×100) became about 0.5 mol %.

Subsequently, the obtained mixed solution was heated and stirred at about 40° C. to evaporate all of the solvent. Evaporation of the solvent was performed while irradiating ultrasonic waves to the mixed solution. Thereby, a precursor of a second coating layer 12, i.e., a reaction precursor of lithium-zirconium oxides was supported on the surface of the positive active material particle 11. Further, the reaction precursor of lithium-zirconium oxides supported on the surface of the positive active material particle 11 was calcined at about 350° C. for about 1 hour while blowing oxygen into the reaction precursor of lithium-zirconium oxides. Thereby, the coated particle 10a according to Example 3 was obtained. The second coating layer 12 of Example 3 consists of lithium-zirconium oxides. Further, when zirconium included in Zr (IV) propoxide had a mol number of about n¹, and the whole transition metal in the positive active material particle 11 had a total atom number of about n², a ratio of n¹ to n² became about 0.5 mol %. As a result of measuring an average particle diameter of the coating particles 10a by the above-described method, the average particle diameter of the coating particles 10a was about 19 μm.

Hereinafter, a ratio of the mol number n¹ of the element M² (zirconium in Example 3) in the second coating layer 12 to the total atom number n² of the whole transition metal atom (nickel atom and cobalt atom in Example 3) is also called as “a coating amount of the second coating layer 12”.

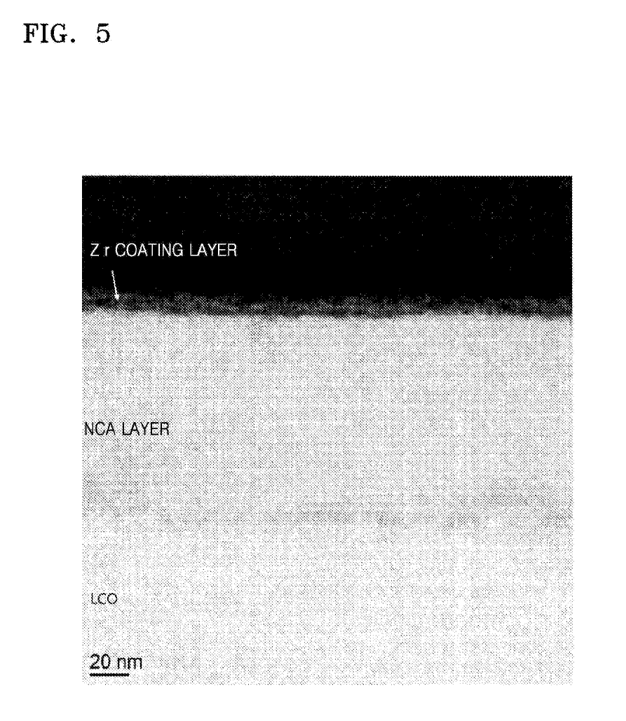

An HAADF-STEM image of the coated particle 10a obtained in Example 3 is shown in FIG. 5. The coated particle 10a of FIG. 5 may include a protection film additionally formed on the second coating layer 12 which is represented by “Zr coating layer” in FIG. 5. Further, a first coating layer 11b is represented by “NCA layer” in FIG. 5. As shown in FIG. 5, it can be seen that the first coating layer 11a and the second coating layer 12 are coated on the LCO particle 11a by preparation methods of Examples 1 and 3. Further, as a result of observing the entire coated particle 10a by HAADF-STEM, it was confirmed that the coated particle 10a was approximately spherical.

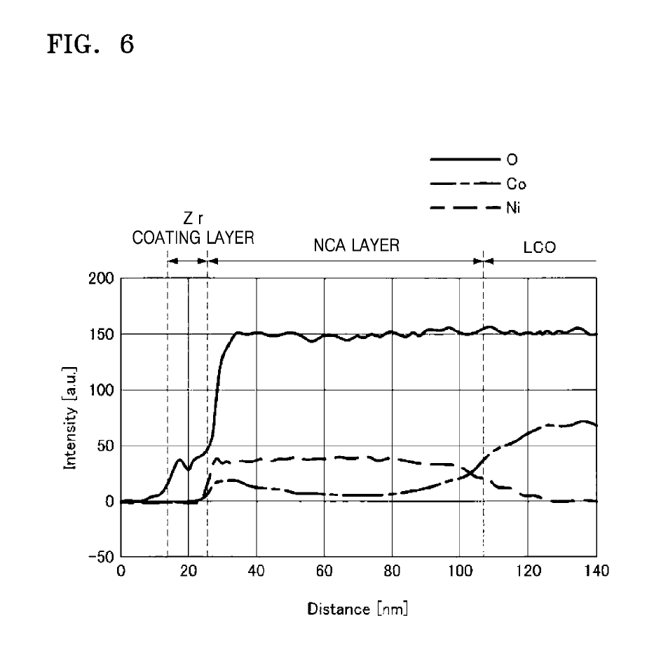

Further, the element distribution of a thickness direction of FIG. 5 was measured by Electron Energy Loss Spectroscopy (EELS). 863GIF Tridiem of Gatan Corporation was used as a measuring device. As a result, an intensity line profile shown in FIG. 6 was obtained. A horizontal axis of FIG. 6 represents a distance (depth) from the surface of a protection film to a measurement face, and a vertical axis of FIG. 6 represents an area density (intensity) of each element of the measurement face. As shown in FIG. 6, the longer a distance from the surface of the coated particle 10a to the measurement face is, the smaller the surface density of nickel atom becomes. Also, the longer the distance from the surface of the coated particle 10a to the measurement face is, the larger the surface density of cobalt atom becomes. Such changes occur in an interface between the LCO particle 11a and the first coating layer 11b and an area in the vicinity of the interface. Such a concentration gradient is estimated to be generated when the precursor of the first coating layer 11b is calcined. Namely, nickel atom in the precursor of the first coating layer 11b is moved into the LCO particle 11a, and cobalt atom in the LCO particle 11a is moved into the precursor of the first coating layer 11b by the calcination.

### Example 4

A powder mixture was prepared by mixing lithium hydroxide and nickel hydroxide at a molar ratio of about Li:Ni=1.0:1.0. The powder mixture and the LCO particle 11a were mixed such that a molar ratio of cobalt atom and nickel atom became about Co:Ni=0.95:0.05. Except this, the same processes as in Example 3 were performed. Positive active material particle 11 had an average particle diameter of about 18 μm.

Coated particle 11a was prepared by the same preparation process as in Example 3 except that Al (III) propoxide was used instead of Zr (IV) propoxide. Except this, the same processes as in Example 3 were performed.

### Example 6

The same processes as in Example 3 were performed except that a 10% lithium methoxide methanol solution and La (III) propoxide were mixed in a mixed solution of tetrahydrofuran and ethyl acetoacetate for about 30 minutes.

### Example 7

Coated particle 11a was prepared by performing the same preparation process as in Example 3 except that Y (III) propoxide was used instead of Zr (IV) propoxide. Except this, the same processes as in Example 3 were performed.

### Example 8

The same processes as in Example 3 were performed except that a 10% lithium methoxide methanol solution and Ce (IV) propoxide were mixed in a mixed solution of tetrahydrofuran and ethyl acetoacetate for about 30 minutes.

### Example 9

Coated particle 11a was prepared by performing the same preparation process as in Example 3 except that Ga (III) propoxide was used instead of Zr (IV) propoxide. Except this, the same processes as in Example 3 were performed.

### Example 10

Coated particle 11a was prepared by performing the same preparation process as in Example 3 except that In (III) propoxide was used instead of Zr (IV) propoxide. Except this, the same processes as in Example 3 were performed.

### Example 11

Coated particle 11a was prepared by performing the same preparation process as in Example 3 except that Ti (IV) propoxide was used instead of Zr (IV) propoxide. Except this, the same processes as in Example 3 were performed.

### Example 12

Coated particle 11a was prepared by performing the same preparation process as in Example 3 except that Nb (V) propoxide was used instead of Zr (IV) propoxide. Except this, the same processes as in Example 3 were performed.

### Example 13

The positive active material particle 11 prepared in Example 1 was classified to prepare positive active material particle 11 having an average particle diameter of about 9.0 μm. Except this, the same processes as in Example 1 were performed.

### Example 14

The positive active material particle 11 prepared in Example 1 was classified to prepare positive active material particle 11 having an average particle diameter of about 32 μm. Except this, the same processes as in Example 1 were performed.

### Example 15

The same preparation process as in Example 1 was performed except that positive active material particle 11 was prepared according to the following processes. First, after mixing lithium carbonate, cobalt oxide, and magnesium hydroxide at a molar ratio of about Li:Co:Mg=1.00:0.99:0.01, the mixture was calcined at about 950° C. for about 4 hours while blowing air into the mixture. Thereby, LCO particle 11a including magnesium atom was obtained. The magnesium atom corresponds to an element M¹. As a result of measuring an average particle diameter of the LCO particle 11a by the above-described method, the average particle diameter of the LCO particle 11a was about 19 μm.

Subsequently, a powder mixture was prepared by mixing lithium hydroxide, nickel hydroxide, and aluminum hydroxide at a molar ratio of about Li:Ni:Al=1.00:0.95:0.05. The powder mixture and the LCO particle 11a were mixed such that a molar ratio of the total atom number of cobalt atom and magnesium atom to the total atom number of nickel atom and aluminum atom became about (Co+Mg):(Ni+Al)=0.95:0.05.

In succession, the powder mixture was composited using a NOB-MINI manufactured by Hosokawa Micron Corporation. Accordingly, a precursor (lithium-nickel-aluminum oxide precursor) of the first coating layer 11b was supported on the surface of the LCO particle. Subsequently, the precursor was calcined at about 750° C. for about 4 hours while blowing oxygen into the precursor. Positive active material particle 11 was obtained by the calcination process. A composition for the positive active material particle 11 was Li(Co_{0.99}Mg_{0.01})_{0.95}(Ni_{0.95}Al_{0.05})_{0.05}O₂. As a result of measuring an average particle diameter of the positive active material particle 11 by the above-described method, the average particle diameter of the positive active material particle 11 was about 19 μm.

### Example 16

A powder mixture was prepared by mixing lithium hydroxide and nickel hydroxide at a molar ratio of about Li:Ni=1.0:1.0. Subsequently, the powder mixture and the LCO particle 11a were mixed such that a molar ratio of the total atom number of cobalt atom and magnesium atom to the atom number of nickel atom became about (Co+Mg):Ni=0.95:0.05. Except this, the same processes as in Example 15 were performed. Positive active material particle 11 had an average particle diameter of about 21 μm.

### Example 17

A powder mixture of lithium hydroxide, nickel hydroxide, and aluminum hydroxide was mixed with LCO particle 11a such that a molar ratio of cobalt to the sum of nickel and aluminum became about Co:(Ni+Al)=0.70:0.30. Except this, the same preparation processes were performed as in Example 1. Positive active material particle 11 had an average particle diameter of about 21 μm.

### Example 18

The same preparation processes were performed as in Example 3 except that the second coating layer 12 had a coating amount of about 0.1 mol %.

### Example 19

The same preparation processes were performed as in Example 3 except that the second coating layer 12 had a coating amount of about 10.0 mol %.

### Example 20

A powder mixture was prepared by mixing lithium hydroxide, nickel hydroxide, and manganese hydroxide at a molar ratio of about Li:Ni:Mn=1.00:0.80:0.20. The powder mixture and the LCO particle 11a were mixed such that a molar ratio of cobalt and the sum of nickel and magnesium became about Co:(Ni+Mn)=0.95:0.05. Except this, the same processes as in Example 1 were performed. Positive active material particle 11 had an average particle diameter of about 20 μm.

### Comparative Example 1

The same preparation processes were performed as in Example 1 except that the LCO particle 11a prepared in Example 1 were used as positive active material particle 11.

### Comparative Example 2

A second coating layer 11b that was the same as in Example 3 was formed on the surface of the LCO particle 11a prepared in Example 1. The same preparation processes were performed as in Example 1 except that a cell for testing was prepared using the coated particle prepared by the second coating layer 11b.

### Comparative Example 3

The same preparation processes were performed as in Example 1 except that an NCM particle having an average particle diameter of about 15 μm was prepared to use the NCM particle as positive active material particle 11.

### Comparative Example 4

A powder mixture of lithium hydroxide, nickel hydroxide, and aluminum hydroxide was mixed with LCO particle 11a such that a molar ratio of cobalt to the sum of nickel and aluminum became about Co:(Ni+Al)=0.50:0.50. Except this, the same preparation processes were performed as in Example 1.

### Comparative Example 5

The same preparation processes were performed as in Example 3 except that the second coating layer 12 had a coating amount of about 15.0 mol %.

### Comparative Example 6

The positive active material particles 11 prepared in Example 1 were classified to prepare positive active material particles 11 having an average particle diameter of about 3.0 μm. Except this, the same processes as in Example 1 were performed.

### Comparative Example 7

The positive active material particle 11 prepared in Example 1 was classified to prepare positive active material particle 11 having an average particle diameter of about 43.0 μm. Except this, the same processes as in Example 1 were performed.

Compositions for the positive active material particle 11, the second coating layers 12, and cell evaluations according to Examples 1 to 20, and Comparative Examples 1 to 7 are listed and represented in Tables 1, 2, and 3 respectively.

TABLE 1

| | Positive active material particle 11 | | | |
|---|---|---|---|---|
| | | Molar ratios | Molar ratios of | Average |
| | | of elements | elements of the first | particle |
| | Compositions for the whole | of the first | coating layer to cobalt | diameters |
| | positive active material particle | coating layer | atom | (μm) |
| Example 1 | LiCo_{0.95}Ni_{0.0475}Al_{0.0025}O₂ | Ni/Al = 95/5 | Co/(Ni + Al) = 95/5 | 19 |
| Example 2 | LiCo_{0.95}Ni_{0.0475}Al_{0.0025}O₂ | Ni/Al = 95/5 | Co/(Ni + Al) = 90/10 | 20 |
| Example 3 | LiCo_{0.95}Ni_{0.0475}Al_{0.0025}O₂ | Ni/Al = 95/5 | Co/(Ni + Al) = 95/5 | 19 |
| Example 4 | LiCo_{0.95}Ni_{0.05}O₂ | Ni/Al = 100/0 | Co/Ni = 95/5 | 18 |
| Example 5 | LiCo_{0.95}Ni_{0.0475}Al_{0.0025}O₂ | Ni/Al = 95/5 | Co/(Ni + Al) = 95/5 | 19 |
| Example 6 | LiCo_{0.95}Ni_{0.0475}Al_{0.0025}O₂ | Ni/Al = 95/5 | Co/(Ni + Al) = 95/5 | 19 |
| Example 7 | LiCo_{0.95}Ni_{0.0475}Al_{0.0025}O₂ | Ni/Al = 95/5 | Co/(Ni + Al) = 95/5 | 19 |
| Example 8 | LiCo_{0.95}Ni_{0.0475}Al_{0.0025}O₂ | Ni/Al = 95/5 | Co/(Ni + Al) = 95/5 | 19 |
| Example 9 | LiCo_{0.95}Ni_{0.0475}Al_{0.0025}O₂ | Ni/Al = 95/5 | Co/(Ni + Al) = 95/5 | 19 |
| Example 10 | LiCo_{0.95}Ni_{0.0475}Al_{0.0025}O₂ | Ni/Al = 95/5 | Co/(Ni + Al) = 95/5 | 19 |
| Example 11 | LiCo_{0.95}Ni_{0.0475}Al_{0.0025}O₂ | Ni/Al = 95/5 | Co/(Ni + Al) = 95/5 | 19 |
| Example 12 | LiCo_{0.95}Ni_{0.0475}Al_{0.0025}O₂ | Ni/Al = 95/5 | Co/(Ni + Al) = 95/5 | 19 |
| Example 13 | LiCo_{0.95}Ni_{0.0475}Al_{0.0025}O₂ | Ni/Al = 95/5 | Co/(Ni + Al) = 95/5 | 9 |
| Example 14 | LiCo_{0.95}Ni_{0.0475}Al_{0.0025}O₂ | Ni/Al = 95/5 | Co/(Ni + Al) = 95/5 | 32 |
| Example 15 | LiCo_{0.9405}Mg_{0.0095}Ni_{0.0475}Al_{0.0025}O₂ | Ni/Al = 95/5 | (Co + Mg)/(Ni + Al) = 95/5 | 19 |
| Example 16 | LiCo_{0.9405}Mg_{0.0095}Ni_{0.05}O₂ | Ni/Al = 100/0 | (Co + Mg)/Ni = 95/5 | 21 |
| Example 17 | LiCo_{0.70}Ni_{0.285}Al_{0.015}O₂ | Ni/Al = 95/5 | Co/(Ni + Al) = 70/30 | 21 |
| Example 18 | LiCo_{0.95}Ni_{0.0475}Al_{0.0025}O₂ | Ni/Al = 95/5 | Co/(Ni + Al) = 95/5 | 19 |
| Example 19 | LiCo_{0.95}Ni_{0.0475}Al_{0.0025}O₂ | Ni/Al = 95/5 | Co/(Ni + Al) = 95/5 | 19 |
| Example 20 | LiCo_{0.95}Ni_{0.04}Mn_{0.01}O₂ | Ni/Mn = 80/20 | Co/(Ni + Mn) = 95/5 | 20 |
| CEx 1 | LiCoO₂ | — | — | 18 |
| CEx 2 | LiCoO₂ | — | — | 18 |
| CEx 3 | LiNi_{0.33}Co_{0.33}Mn_{0.33}O₂ | — | — | 15 |
| CEx 4 | LiCo_{0.50}Ni_{0.475}Al_{0.025}O₂ | Ni/Al = 95/5 | Co/(Ni + Al) = 50/50 | 22 |
| CEx 5 | LiCo_{0.95}Ni_{0.0475}Al_{0.0025}O₂ | Ni/Al = 95/5 | Co/(Ni + Al) = 95/5 | 19 |
| CEx 6 | LiCo_{0.95}Ni_{0.0475}Al_{0.0025}O₂ | Ni/Al = 95/5 | Co/(Ni + Al) = 95/5 | 3 |
| CEx 7 | LiCo_{0.95}Ni_{0.0475}Al_{0.0025}O₂ | Ni/Al = 95/5 | Co/(Ni + Al) = 95/5 | 43 |

CEx means Comparative Example.

TABLE 2

| | Coating layer | |
|---|---|---|
| | | Coating amount (mol %) |
| | Coating | (M2/transition metal in |
| | element (M2) | positive active material) |
| Example 1 | — | — |
| Example 2 | — | — |
| Example 3 | Zirconium | 0.5 |
| Example 4 | Zirconium | 0.5 |
| Example 5 | Aluminum | 0.5 |
| Example 6 | Lanthanum | 0.5 |
| Example 7 | Yttrium | 0.5 |
| Example 8 | Cerium | 0.5 |
| Example 9 | Gallium | 0.5 |
| Example 10 | Indium | 0.5 |
| Example 11 | Titanium | 0.5 |
| Example 12 | Niobium | 0.5 |
| Example 13 | — | — |
| Example 14 | — | — |
| Example 15 | — | — |
| Example 16 | — | — |
| Example 17 | — | — |
| Example 18 | Zirconium | 0.1 |
| Example 19 | Zirconium | 10 |
| Example 20 | — | — |
| Comparative Example 1 | — | — |
| Comparative Example 2 | Zirconium | 0.5 |
| Comparative Example 3 | — | — |
| Comparative Example 4 | — | — |
| Comparative Example 5 | Zirconium | 15 |
| Comparative Example 6 | — | — |
| Comparative Example 7 | — | — |

TABLE 3

| | Cell evaluation | |
|---|---|---|
| | Initial capacity | Retention |
| | (Example 1 having 100) | rate after 50 cycles |
| Example 1 | 100 | 87% |
| Example 2 | 100 | 85% |
| Example 3 | 97 | 90% |
| Example 4 | 96 | 84% |
| Example 5 | 94 | 87% |
| Example 6 | 97 | 85% |
| Example 7 | 94 | 82% |
| Example 8 | 92 | 82% |
| Example 9 | 85 | 80% |
| Example 10 | 86 | 82% |
| Example 11 | 89 | 83% |
| Example 12 | 94 | 85% |
| Example 13 | 91 | 89% |
| Example 14 | 96 | 89% |
| Example 15 | 95 | 89% |
| Example 16 | 98 | 82% |
| Example 17 | 90 | 83% |
| Example 18 | 94 | 86% |
| Example 19 | 87 | 95% |
| Example 20 | 95 | 84% |
| Comparative Example 1 | 53 | 48% |
| Comparative Example 2 | 45 | 55% |
| Comparative Example 3 | 62 | 45% |
| Comparative Example 4 | 65 | 54% |
| Comparative Example 5 | 62 | 63% |
| Comparative Example 6 | 53 | 49% |
| Comparative Example 7 | 70 | 69% |

According to Tables 1 to 3, it is confirmed that Examples 1 to 20 having positive active material particle 11 or coated particle 10a have substantially improved discharge capacities and cycle characteristics compared to Comparative Examples 1 to 7.

Namely, it is represented that positive active material particle 11 desirably have at least a first coating layer 11b when comparing Examples 1 to 20 with Comparative Examples 1 and 2. Further, it is represented that compositions for the positive active material particle 11 desirably satisfy Formula 1 when comparing Examples 1 to 20 with Comparative Examples 3 and 4. Further, it is represented that the second coating layer 12 desirably have a coating amount of about 10.0 mol % or less if a second coating layer 12 is formed on the surface of the positive active material particle 11 when comparing Examples 1 to 20 with Comparative Example 5. Further, it is represented that the positive active material particle 11 having an average particle diameter of about 5 μm to about 35 μm is preferable when comparing Examples 1 to 20 with Comparative Examples 6 and 7.

It should be understood that exemplary embodiments described herein should be considered in a descriptive sense only and not for purposes of limitation. Descriptions of features, advantages, or aspects within each exemplary embodiment should be considered as available for other similar features, advantages, or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. An all-solid lithium ion secondary battery comprising a positive electrode comprising a positive active material particle and a solid electrolyte particle in contact with the positive active material particle,
wherein the positive active material particle comprises:
a lithium cobalt oxide particle;
a first coating layer which comprises nickel and is on at least a portion of a surface of the lithium cobalt oxide particle; and
at least one element M¹ selected from B, Mg, Al, Si, Sc, Ti, V, Cr, Mn, Fe, Cu, Zn, Ga, Y, Zr, Nb, Mo, Ru, In, Sn, Sb, La, Ce, Pr, Eu, Tb, Hf, Ta, and Pb.

2. The all-solid lithium ion secondary battery of claim 1, wherein the first coating layer further comprises at least one element selected from lithium, oxygen, and M¹.

3. The all-solid lithium ion secondary battery of claim 1, wherein an entirety of the positive active material particle has a composition represented by the following Formula 1:
LiₓNi_{y}Co_{z}M¹_{1-y-z}O₂ Formula 1
wherein x, y, z are values satisfying 0.5<x<1.2, 0<y<0.4, z>0.6, and y+z≦1.0.

4. The all-solid lithium ion secondary battery of claim 1, wherein the positive active material particle has an average particle diameter of about 5 micrometers to about 35 micrometers.

5. The all-solid lithium ion secondary battery of claim 1, wherein the element M¹ is at least one element selected from Mg, Al, and Mn.

6. The all-solid lithium ion secondary battery of claim 1, wherein the positive active material particle has a molar ratio of nickel to cobalt which continuously varies from the surface of the positive active material particle toward the center of the positive active material particle.

7. The all-solid lithium ion secondary battery of claim 1, wherein the lithium cobalt oxide particle comprises M¹.

8. The all-solid lithium ion secondary battery of claim 1, wherein the positive active material particle further comprises a second coating layer on at least a portion of the first coating layer, and wherein the second coating layer comprises at least one element M² selected from B, Mg, Al, Si, Sc, Ti, V, Cr, Mn, Fe, Cu, Zn, Ga, Y, Zr, Nb, Mo, Ru, In, Sn, Sb, La, Ce, Pr, Eu, Tb, Hf, Ta, and Pb.

9. The all-solid lithium ion secondary battery of claim 7, wherein the positive active material particle has a molar content of M² to total moles of all transition metals in the positive active material of about 10 mol % or less.

10. The all-solid lithium ion secondary battery of claim 8, wherein the element M² is at least one element selected from Al, Ti, Ga, Y, Zr, Nb, In, La, and Ce.

11. The all-solid lithium ion secondary battery of claim 1, wherein the positive active material particle has a spherical shape.

12. The all-solid lithium ion secondary battery of claim 1, wherein the solid electrolyte particle is a sulfide solid electrolyte particle.

13. The all-solid lithium ion secondary battery of claim 12, wherein the sulfide solid electrolyte particle comprises at least sulfur and lithium, and further comprises at least one element selected from phosphorous, silicon, boron, aluminum, germanium, zinc, gallium, indium, and a halogen element.

14. The all-solid lithium ion secondary battery of claim 12, wherein the sulfide solid electrolyte particle comprises:
lithium sulfide; and
at least one selected from silicon sulfide, phosphorous sulfide, and boron sulfide.

15. The all-solid lithium ion secondary battery of claim 12, wherein the sulfide solid electrolyte particle comprises Li₂S and P₂S₅.
